(19) United States
(12) Patent Application Publication
(10) Pub. No.: US 2009/0129513 A1
(43) Pub. Date: May 21, 2009

(54) Apparatus, methods, and computer program products providing partial MIMO reception and decoding

(75) Inventors: Jukka Henriksson, Espoo (FI); Maarit Melvasalo, Kirkkonummi (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/313,190

(22) Filed: Nov. 17, 2008

Related U.S. Application Data
(60) Provisional application No. 61/003,336, filed on Nov. 16, 2007.

(51) Int. Cl. H04L 27/06

(52) U.S. Cl. 375/340

(57) ABSTRACT

In a first aspect, there are received m transmitted signals of a multiple input/multiple output transmission comprising n transmitted signals corresponding to n streams of n different polarizations, where n is a positive integer greater than one, and m is an integer less than n. The m received signals are decoded to obtain information for the corresponding streams. Apparatus and computer programs to implement the invention are also detailed.

### CROSS-REFERENCE

This patent application claims priority under 35 U.S.C. §119(e) from U.S. Provisional Patent Application No. 61/003,336, filed Nov. 16, 2007, the disclosure of which is incorporated by reference herein in its entirety.

### TECHNICAL FIELD

The exemplary and non-limiting embodiments of this invention relate generally to wireless communication systems, apparatus, methods and computer program products and, more specifically, relate to multiple input/multiple output (MIMO) communications.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations are utilized herein:

DVB digital video broadcasting

HDTV high definition television

LOS line of sight

MIMO multiple input/multiple output

MMSE minimum mean square error

OFDM orthogonal frequency division multiplexing

SDTV standard definition television

XPD cross-polarization discrimination

Conventional MIMO systems are designed assuming that the receiver will decode all of the transmitted data. Other techniques exist, for example, for radio links, where two single-carrier signals are transmitted as two cross-polarized streams. There are also systems where the cross-polarized signals are detected using cross-polarization cancellers. In conventional DVB systems, only a single transmit antenna is used.

### SUMMARY

The foregoing and other problems are overcome, and other advantages are realized, by the use of the exemplary embodiments of this invention.

In a first aspect thereof the exemplary embodiments of this invention provide a method comprises receiving m transmitted signals of a multiple input/multiple output transmission comprising n transmitted signals corresponding to n streams of n different polarizations, where n is a positive integer greater than one, and m is an integer less than n, and the m received signals are decoded to obtain information for the corresponding streams.

In accordance with another exemplary embodiment of the invention is a memory readable by a processor, tangibly embodying a program of instructions. When the program of instructions are executed by the processor, the result in operations comprises: (a) receiving m transmitted signals of a multiple input/multiple output transmission comprising n transmitted signals corresponding to n streams of n different polarizations, where n is a positive integer greater than one, and m is an integer less than n, and (b) decoding the m received signals to obtain information for the corresponding streams.

In accordance with another exemplary embodiment of the invention is an apparatus that includes a receiver and a decoder. A receiver is configured to receive m transmitted signals of a multiple input/multiple output comprising n transmitted signals corresponding to n streams of n different polarizations, where n is a positive integer greater than one and m is an integer less than n. Then, a decoder is configured to decode the m received signals to obtain information for the corresponding streams.

In accordance with yet another exemplary embodiment of the invention is an apparatus comprising a processor configured to: (a) receive m transmitted signals of a multiple input/multiple output transmission comprising n transmitted signals corresponding to n streams of n different polarizations, where n is a positive integer greater than one, and m is an integer less than n, and (b) decode the m received signals to obtain information for the corresponding streams.

### BRIEF DESCRIPTION OF THE DRAWINGS

In the attached Drawing Figures:

FIG. 1 illustrates an exemplary transmitter 50 that may be utilized in conjunction with the exemplary embodiments of the invention;

FIG. 2 illustrates an exemplary receiver 70 that may be utilized in conjunction with the exemplary embodiments of the invention;

FIG. 3 shows a general, exemplary arrangement 90 with two cross-polarized transmit antennas;

FIG. 4 illustrates exemplary transmitted waveforms from the two cross-polarized antennas of FIG. 3;

FIG. 5A illustrates the orientation of a single reception antenna M1 with respect to the polarization of a signal transmitted from an antenna A1;

FIG. 5B shows an exemplary flow diagram for the operations described in Table 1;

FIG. 6 illustrates two examples of two antennas separated by a distance d;

FIG. 7 depicts an exemplary arrangement of three antennas;

FIG. 8 shows an exemplary arrangement of two pairs of two cross-polarized antennas;

FIG. 9 shows a simplified block diagram of various electronic devices that are suitable for use in practicing the exemplary embodiments of this invention;

FIG. 10 shows a simplified block diagram of additional electronic devices that are suitable for use in practicing the exemplary embodiments of the invention;

FIG. 11 illustrates an exemplary channel matrix for the block diagram shown in FIG. 10;

FIG. 12 depicts a flowchart illustrating one non-limiting example of a method for practicing the exemplary embodiments of this invention;

FIG. 13 depicts a flowchart illustrating another non-limiting example of a method for practicing the exemplary embodiments of this invention; and

FIG. 14 depicts a flowchart illustrating another non-limiting example of a method for practicing the exemplary embodiments of this invention.

### DETAILED DESCRIPTION

One problem is that to send the vast amount of data needed, for example, by HDTV services, a preferred way to implement this spectrally efficiently is to use a MIMO system with at least two antennas on the transmitter side and at least two antennas on the receiver side. Most conventional MIMO schemes (e.g., with double rate) provide no straightforward way or no way at all for a receiver with a single antenna to decode anything of the transmitted signals. Hence, introducing a dual-antenna MIMO system would require users to update the receiver antennas in order to benefit from the capacity increase of the multiple transmit antennas. The cost of such reinstallations might become prohibitive for introducing the new broadcasting system. If users could decode at least part (e.g., about half) of the services or data with a single existing antenna and corresponding cabling installation, the new system might be more viable (e.g., commercially), particularly since only the receiver may need to be upgraded.

Exemplary embodiments of the invention provide apparatus, methods, computer programs, systems and techniques that enable a user to receive and decode only a portion (e.g., half) of a MIMO transmission utilizing fewer antennas (e.g., one antenna) than the number of transmit antennas. In one non-limiting, exemplary embodiment, the transmitter antennas are cross-polarized.

Exemplary embodiments of the invention may be utilized, for example, in conjunction with broadcast services mainly for terrestrial transmissions using freely propagating radio waves. One exemplary embodiment of the invention provides “backwards compatibility” DVB systems where the existing antenna and cabling installations, such as existing roof-top antennas, are used to receive at least part of the future full set of services. These full set of services are assumed to be transmitted using a MIMO system with at least two antennas where—for capacity reasons—a corresponding enhanced receiver would use at least two antennas. This approach would be desirable for the enhanced receivers using maximal installation complexity as they could then receive the entire set of transmitted services. However, especially during a transitional period when these new systems enter the market, there may also be a desire or need to use the existing antenna installations to receive at least part of the services. Exemplary embodiments of the invention address this problem and, for example, present a method where these two requirements can be met simultaneously.

While the exemplary embodiments of the invention will be described below primarily in the context of the OFDM based DVB-T or DVB-T2 system, it should be appreciated that the exemplary embodiments of this invention are not limited for use with only this one particular type of wireless communication system or transmission, and that they may be used to advantage in other wireless communication systems and/or for other types of transmissions. For example, exemplary embodiments of the invention may be utilizing in a broader sense with general signals, where partial decoding of the transmitted signal is a desirable feature.

The idea of backward comparability in broadcast systems (e.g., DVB-T2, DVB-H2) is that even though the capacity is increased with multiple transmit antennas, it is still possible to receive part of the transmitted services with a fewer number of antennas or only a single receiver antenna. However, in order to obtain multiplexing gain, i.e., to detect all the transmitted services, multiple receiver antennas are needed. As further described below, in some exemplary embodiments the transmitter and receiver are designed in such a way that a portion of the signal (e.g., a single antenna receiver part of the signal) can be received and decoded (e.g., corresponding to the basic broadcast services). In a further exemplary embodiment, a receiver with multiple antennas can decode the entire transmitted signal (e.g., including additional portion(s) corresponding to “new” or additional services). When only a single receive antenna is available, the additional services may be considered as interference. The quality of reception of the desired part of the signal (e.g., the service intended for all users) could be enhanced with a multi-stage inter-antenna interference cancellation receiver as described below. The cancellation may be based on reliable channel estimates, for example, from both transmit antennas and knowledge of the symbol constellations.

Below are described various exemplary embodiments of the invention. It should be noted that any suitable aspects of the various exemplary embodiments may be utilized in conjunction with one or more other aspects of other exemplary embodiments. That is, the below-described exemplary embodiments may be utilized in conjunction with one another where suitable.

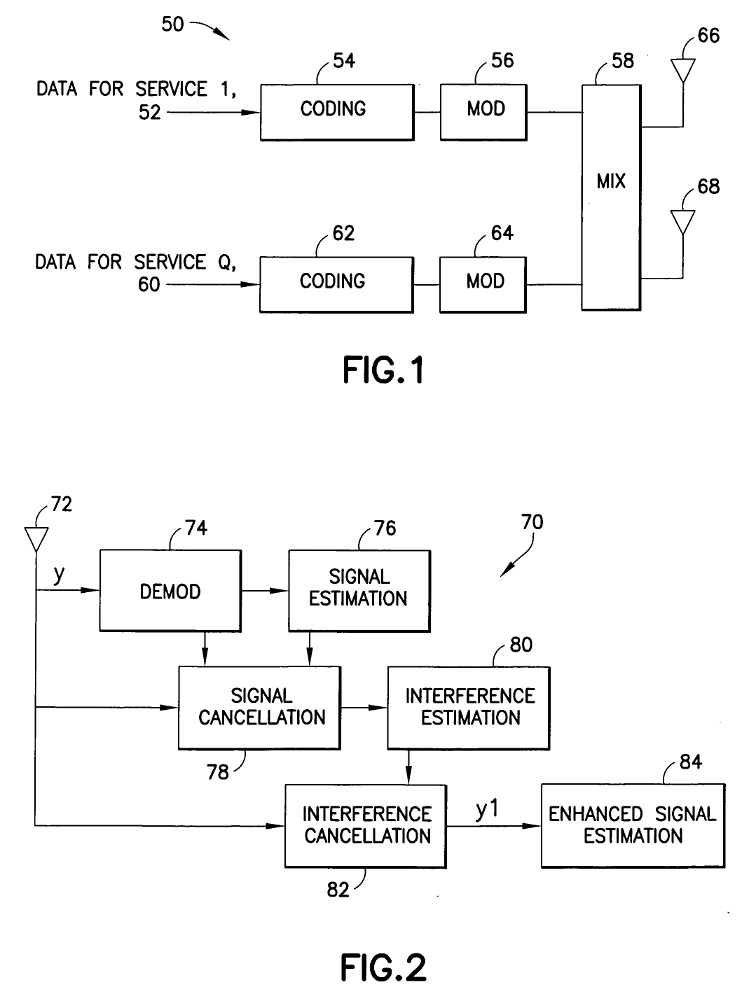

FIG. 1 illustrates an exemplary transmitter 50 that may be utilized in conjunction with the exemplary embodiments of the invention and FIG. 2 illustrates an exemplary receiver 70 that may be utilized in conjunction with the exemplary embodiments of the invention.

In FIG. 1, the exemplary transmitter 50 receives data for a first service (service 1) 52 at a first coding block 54 and encodes it. A first modulator (MOD) 56 modulates the encoded first stream and passes it to a mixer (MIX) 58. Data for a second service (service 2) 60 is received by a second coding block 62 and encoded. A second modulator (MOD) 64 modulates the encoded second stream and passes it to the MIX 58. The MIX 58 combines the modulated encoded streams and transmits them as a MIMO transmission via a plurality of antennas 66, 68. Other processes may be performed by the coding blocks 54, 62, in conjunction with the coding blocks 54, 62 or by additional blocks prior to or after processing by the coding blocks 54, 62 or processing by the modulators 56, 64.

The exemplary transmitter is a multi-code word type transmitter where two (or more) independently coded service streams are transmitted from multiple antennas (e.g., a corresponding number of antennas). Different services may be separately coded and modulated (e.g., with dedicated coding rates and modulation for each service). Different signal powers may be allocated to different service streams. The different streams can be transmitted from separate antennas 66, 68 or they can be mixed with a mixing matrix. In accordance with exemplary embodiments of the invention, with multi-code word transmission systems a single antenna receiver is, under some conditions, capable of decoding, for example, one of the transmitted streams while regarding the other signal as interference. Furthermore, it is possible to enhance the quality of the received desired signal by using an interference cancellation receiver, such as the exemplary receiver depicted in FIG. 2.

In FIG. 2, the receiver 70 receives a signal y via an antenna 72. A demodulator block 74 demodulates the received signal and outputs the result to a signal estimation block 76 and a signal cancellation block 78. The signal estimation block 76 derives an estimate of the signal and passes it to the signal cancellation block 78. The signal cancellation block 78 utilizes the estimation to cancel the signal and output to an interference estimation block 80. The interference estimation block 80 estimates the interference and outputs the estimation to an interference cancellation block 82. The interference cancellation block 82 also receives the received signal y as an input, subsequently cancels (attempts to cancel) the estimated interference and provides its output to an enhanced signal estimation block 84. The enhanced signal estimation block 84 provides an enhanced signal estimation.

The conditions needed for signal detection may depend on various system parameters such as the antenna configuration (e.g., number of antennas, their orientation, spacing) both at the transmitter and receiver, as non-limiting examples. In addition, the radio channel conditions between the transmitter and receiver and the signal powers may influence the performance. In order to obtain multiplexing gain, the antenna placement should preferably be such that observed channels are nearly independent (e.g., to the maximal extent).

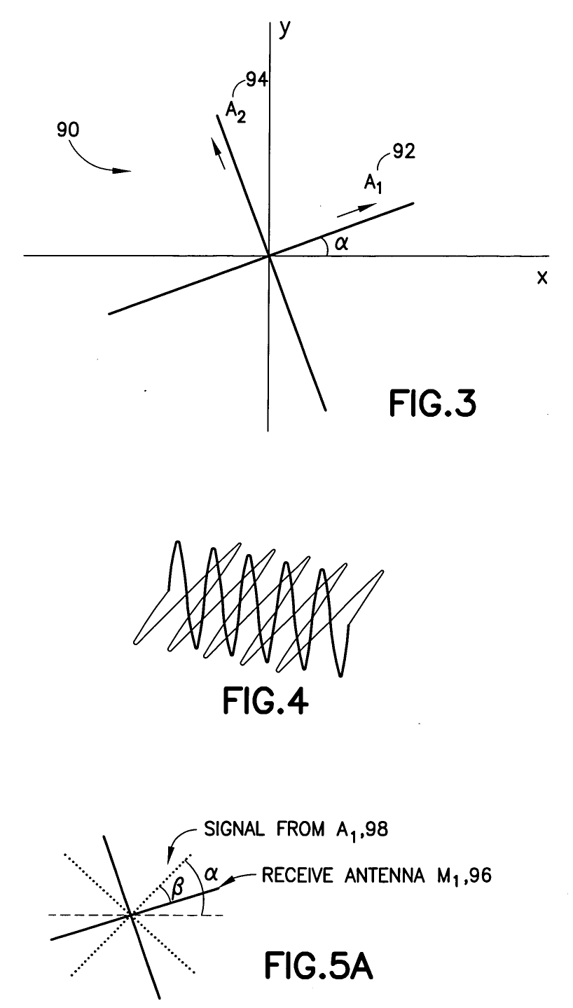

Alternatively or additionally to spatial separation, antenna separation can be obtained via different polarizations. For example, FIG. 3 shows a general, exemplary arrangement 90 with two cross-polarized transmit antennas A₁ 90 and A₂ 92. FIG. 4 illustrates exemplary transmitted waveforms from the two cross-polarized antennas A₁ 90 and A₂ 92. In some exemplary cases, for example, utilizing a LOS channel and properly orientated antennas, one out of the two transmitted signals can be detected even with existing single antenna receivers. This received signal may typically contain components of both transmitted signals, but according to the design of the transmitter and receiver, and in accordance with exemplary embodiments of the invention, the quality of the desired signal is adequate for reception and decoding.

Below, one non-limiting, exemplary MIMO model is described. Consider two cross-polarized antennas with an angle α at the transmitter (see FIG. 3) and one or two receive antennas. Assume that a “backwards compatible receiver” uses only one pre-existing single-polarization antenna, normally horizontally polarized. In a full MIMO reception, the receiver uses two cross-polarized antennas. In accordance with FIG. 3, the original signals s₁ and s₂ are connected in the transmitter to antennas A₁ and A₂ using the following 2×2 mixing matrix:

$$B = [ \begin{matrix}cos ( α ) & sin ( α ) \\ - sin ( α ) & cos ( α )\end{matrix} ] . \qquad ( 1 )$$

Consequently. the transmitted signals, x₁ and x₂, from antennas A₁ and A₂, are a linear combination of the original signals s₁ and s₂ and can be expressed as:

x=Bs, (2)

where x=[x₁ x₂]T and s=[s₁ s₂]^{T} are 2×1 vectors. The channel matrix: H′ for the case of 2×2 MIMO is defined as:

$${H}^{′} = [ \begin{matrix}{h}_{11}^{′} & {h}_{12}^{′} \\ {h}_{21}^{′} & {h}_{22}^{′}\end{matrix} ] , \qquad ( 3 )$$

where h′_{mq} is the complex channel coefficient from the q^{th} transmit antenna to the m^{th} receiver antenna. This model is for the flat fading case. For DVB type OFDM systems with cyclic prefix, the frequency selective channel can be regarded in the frequency domain as a flat fading channel. Consequently, the exemplary model given in equation (3) is sufficient for describing the physical channel in a large variety of systems.

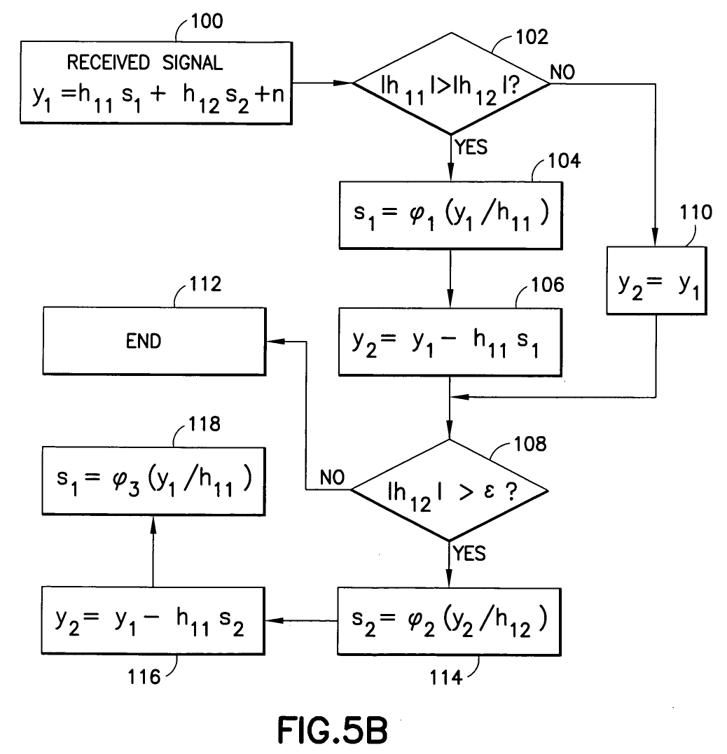

The received signal is also influenced by the orientation of the receiver antenna(s). FIG. 5A illustrates the orientation of a single reception antenna M₁ 96 with respect to the polarization of a signal 98 transmitted from an antenna A₁. This is taken into account in the signal model by combining the MIMO channel matrix H′ with an orientation matrix G as G H′. For an example of the matrix G, it is assumed that both the transmitter and the receiver have two cross polarized antennas, and the channel is a LOS channel. The angle between the receiver antenna M₁, and the signal arriving from the transmit antenna A₁ is denoted as β (see FIG. 5). In this case, the matrix G can be written as:

$$G = [ \begin{matrix}cos ( β ) & - sin ( β ) \\ sin ( β ) & cos ( β )\end{matrix} ] . \qquad ( 4 )$$

Correspondingly, the received signal can be written with the commonly used MIMO system model as:

y=GH′Bs+n=Hs+n, (5)

where n is the noise term. When the receiver has only a horizontal (normal) antenna, the received signal is the first term of vector y, i.e., y₁. By setting α=45° at the transmitter, the angle β at the receiver is also 45°. Further assuming an ideal case without any imperfections and perfect orientation of the antennas, i.e., H′=I, the waveform at the single antenna receiver output is as follows:

y₁=x₁ cos(β)−x₂ sin(β)=s₁. (6)

In a general case, there is likely some amount of inter-antenna interference due to channel and antenna imperfections. Consequently, the signal received at one antenna can be written as a super-composition of the two service streams and noise:

y₁=h₁₁s₁+h₁₂s₂+n, (7)

where h₁₁ and h₁₂ are the composite complex channel gains from antennas A₁ and A₂ and normally the magnitude of h₁₁ is clearly larger than that of h₁₂. The influence of both transmitter and receiver antennas is included in these channel coefficients, i.e., H=G H′B. Knowledge of the MIMO channel parameters is generally important in order to obtain good quality estimates of the desired signal. Therefore, typically in a wireless system pilot symbols are inserted in order to facilitate channel estimation. The pilots can be embedded in the signal or they can be dedicated pilot symbols, as non-limiting examples. When the pilot structure with multi-antenna transmission is orthogonal in frequency, time or code, it is possible with a single antenna receiver to obtain channel estimates (e.g., h₁₁ and h₁₂) for all the transmit antennas. Note that there are several possibilities for the arrangement of the pilots. For example, one option is to use separate dedicated pilots per antenna.

In order to improve the quality of the desired signal, s₁, the available knowledge of the interference can be exploited. The transmitter can be designed in such a way that the receiver with a single antenna also obtains some useful information of all the transmitted streams. Additionally to the knowledge of MIMO channel parameters, the common signaling in a broadcast system, such as DVB, may be used to indicate the symbol constellations of all services. Using this information, an interference cancellation type receiver may be applied to reduce the amount of interference, for example, after initial symbol estimation.

For OFDM systems such as DVB, the cancellation is naturally performed for each subcarrier. A one-stage interference cancellation receiver is shown in FIG. 2. The reliability of the symbol estimates and interference estimates may depend on the signal strength, which itself may be influenced by the transmission power, noise and channel characteristics. Assuming for simplicity that the transmission and noise powers are the same, the reliability of the signals can be evaluated via the magnitude of the channel coefficients, i.e., |h₁₁|, etc. Even though typically |h₁₁|>|h₁₂|, it might be that due to frequency selective channels for some subcarriers |h₁₁|>|h₁₂|. In this case, the signal estimation based on the received signal is not necessarily reliable since the interfering signal is stronger than the desired signal. Consequently, the receiver algorithm may be designed such that in this case the interference cancellation stage is applied first and the desired signal is estimated only after cancellation of the interference.

A pseudo code of this exemplary one-stage interference cancellation receiver is given in Table 1. Extensions to multiple cancellation stages is straightforward. It is assumed here that stream s₁ is the desired signal. When the amount of interference is very low, i.e., |h₁₂| is small, no accurate estimates of the interfering symbols can be obtained and correspondingly it may not be desirable to cancel the term. Therefore a threshold, ε>0, is set for applying the interference cancellation stage. The symbol decision rules are denoted as φ₁, φ₂ and φ₃ (e.g., these may be soft or hard decisions—in general, they may be nonlinear monotonic mappings).

TABLE 1
Pseudo code of the exemplary receiver algorithm for a single
interference cancellation stage with φ₁ denoting the
first stage symbol decision rule for service 1.

| | | |
|---|---|---|
| Received signal | | y₁ = h₁₁ s₁ + h₁₂ s₂ + n |
| | If \|h₁₁\| > \|h₁₂\| | |
| Initial symbol estimates | | s₁ = φ₁ (y₁/h₁₁) |
| Signal cancellation | | y₂ = y₁ − h₁₁ s₁ |
| | Else | |
| | | y₂ = y₁ |
| | End | |
| | If \|h12\| > ε | |
| Interference estimate | | s₂ = φ₂ (y₂/h₁₂) |
| Interference cancellation - | | y₁ = y₁ − h₁₂ s₂ |
| new estimate of y₁ | | |
| | End | |
| Final symbol estimates | | s₁ = φ₃ (y₁/h₁₁) |

FIG. 5B shows an exemplary flow diagram for the operations described in Table 1. Block 100 is the received signal. Block 102 checks if |h₁₁|>|h₁₂|. If yes at block 102, the initial symbols are estimated (block 104) and signal cancellation is performed (block 106) with the result being passed to block 108. If no at block 102, y₂=y₁ (block 110) and the result is passed to block 108. Block 108 checks if |h₁₂|>ε. If no at block 108, the operations end (block 112). If yes at block 108, interference estimation is performed (block 114) and interference cancellation is performed (block 116) to obtain a new estimate of y₁ with the operations ending thereafter with the final symbol estimates (block 118).

Further improvements in performance may be obtained if the symbols are estimated after first decoding using error correcting code information. However, this may increase the complexity and memory requirements of the receiver. Also, additional cancellation stages may be applied in order to improve performance.

Users that have two (or more) receiver antennas will be able to receive the additional broadcast information (e.g., new TV channels or extra information to update SDTV to HDTV). In this case, any standard MIMO receiver, such as MMSE and/or interference cancellation receiver, can be used in solving both s₁ and s₂ from equation (5).

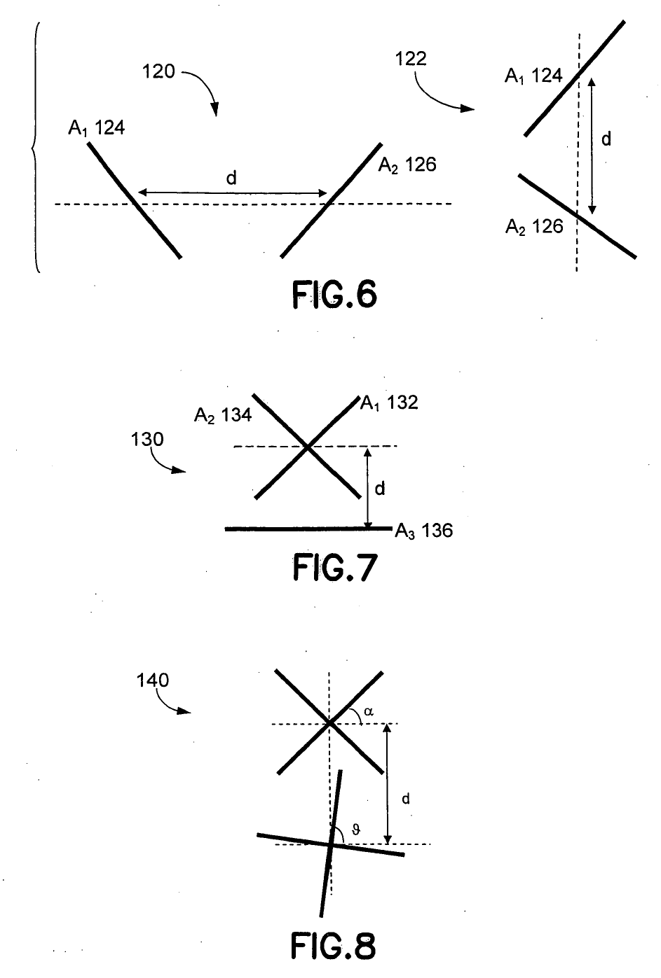

Further alternatives and additional solutions are discussed below. It is worth noting that even if a preferred implementation would use strictly cross-polarized antennas (i.e., 90 degree angle between the antennas), one could easily expand the exemplary techniques to also include non-perpendicular designs. This requires the use of two different angles (α and ζ) and some straightforward changes in the mixing matrix (1). The benefits of using such an approach are not clear but it might occur if one expands an old transmitter installation with a new antenna and puts it, e.g., at a 45 or 60 degree angle with respect to the existing antenna. Additionally, the two cross-polarized antennas can be spatially separated (seen FIG. 6). This might help to reduce the cross-polarization discrimination (XPD) due to antenna couplings. FIG. 6 illustrates two examples 120, 122 of two antennas A₁ 124, A₂ 126 separated by a distance d.

In addition to cross-polarized antennas, spatially separated antennas might be used in order to provide transmit diversity. For example, a combination of three antennas, as seen in FIG. 7, could be beneficial in DVB systems. FIG. 7 depicts an exemplary arrangement 130 of three antennas A₁ 132, A₂ 134, A₃ 136 where antennas A₁ 132 and A₂ 134 are cross-polarized and separated from A₃ 136 by a distance d. In this case, the transmitted signal given in equation (2) would have a third component x₃.

The extra antenna (A₃ 136) is used to provide transmit diversity for one service, for example, only for the desired signal. In this case, the mixing matrix can be written as:

$$B = [ \begin{matrix}cos ( α ) & sin ( α ) & 0 \\ - sin ( α ) & cos ( α ) & 0 \\ 0 & 0 & 1\end{matrix} ] . \qquad ( 8 )$$

It is assumed here that the angle α is defined as the angle between antennas A₃ 136 and A₁ 132. To obtain gain from the transmit diversity, some amount of space-time or space-frequency coding may be used. Consequently, the transmitted signals, x₁, x₂ and x₃, from antennas A₁ 132, A₂ 134 and A₃ 136, are given in a matrix form as follows:

X=BS. (9)

Here the dimension of both the transmit signal matrix X and the symbol matrix S is 3×2. This means that they span over two time (or frequency) instances (i and i+1). For example, S can be defined by expanding the orthogonal space-time block code to the following form:

$$S = [ \begin{matrix}{s}_{1} ( i ) & - {s}_{1}^{*} ( i + 1 ) \\ {s}_{2} ( i ) & {s}_{2} ( i + 1 ) \\ {s}_{1} ( i + 1 ) & {s}_{1}^{*} ( i )\end{matrix} ] . \qquad ( 10 )$$

In case the transmit antennas are as shown in FIG. 7 and the receiver has horizontally and vertically polarized antennas, a channel from the three transmit antennas to the two receiver antennas can be written as:

$${H}^{″} = [ \begin{matrix}{h}_{11}^{′} cos ( β ) - {h}_{21}^{′} sin ( β ) & {h}_{12}^{′} cos ( β ) - {h}_{22}^{′} sin ( β ) & {h}_{13}^{′} cos ( ω ) \\ {h}_{11}^{′} sin ( β ) + {h}_{21}^{′} cos ( β ) & {h}_{12}^{′} sin ( β ) + {h}_{22}^{′} cos ( β ) & {h}_{23}^{′} sin ( ω )\end{matrix} ] \qquad ( 11 )$$

Here, ω is the angle between the signal received from antenna A₃ and the receiver antenna M₁. The coefficients h′_{mq} (m={1,2} and q={1,2,3}) are the MIMO channel coefficients from cross-polarized transmit antennas to virtual cross-polarized receiver antennas similar to the 2×2 case. The received signal model based on equation (5) is now:

Y=H″BS+N=HS+N. (12)

In the backwards compatible case, only one antenna may be available. This means that only the first row of Y would be used. Setting ω=0 implies that transmit antenna A₃ and the receiver antenna are perfectly aligned. For simplicity, an ideal case, where h′₂₁=h′₁₂=h′₂₃=0 and ω=0 is assumed in the following. In this case, the received signal at the two consecutive frequency (or time) instants can be written as:

(h′₁₁ cos(β)cos(α)+h′₂₂ sin(β)sin(α))s₁(i)+(h′₁₁ cos(β)sin(α)−h′₂₂ sin(β)cos(α))s₂(i)+h′₁₃s₁(i+1)

and

−(h′₁₁ cos(β)cos(α)+h′₂₂ sin(β)sin(α))s₁*(i+1)+(h′₁₁ cos(β)sin(α)−h′₂₂ sin(β)cos(α))s₂(i+1)+h′₁₃s₁*(i).

These expressions can be further simplified by also assuming that the orientation of the cross-polarized antennas is optimal (i.e., β=α=45°). and that h₁₁′=h₂₂′. Now the received signals are:

y₁(i)=h′₁₁s₁(i)+h′₁₃s₁(i+1) (13)

y₁(i+1)=−h′₁₁s₁*(i+1)+h′₁₃s₁*(i). (14)

This can be alternatively written with the standard MIMO matrix equation y=H ś₁, by defining the channel matrix as:

$$= [ \begin{matrix}{h}_{11}^{′} & {h}_{13}^{′} \\ {h}_{{13}^{*}}^{′} & - {h}_{11}^{′ *}\end{matrix} ] , \qquad ( 15 )$$

and the signal vector ś₁=[s₁(i) s₁(i+1)]^{T}. In this ideal case, the influence of the second service stream s₂ cancels out similar to the 2×1 case. Additionally, now transmit diversity is available, assuming the distance d between the antennas is large enough. In practice, inter-antenna interference may influence the performance and the interference cancellation receiver, given in Table 1, could be used to enhance the performance. The transmit diversity may be taken into account in the estimation of the desired symbol by joint estimation of two subcarriers or two temporal symbols, i.e., solving equations (13) and (14) simultaneously. Otherwise the extension of the algorithm given in Table 1 is straightforward to this 3×1 case.

First joint symbol estimates \check{s}₁ are obtained, for example, with:

\check{s}₁=φ₁ [symbol] ⁻¹y). (16)

Next, the signal cancellation stage, interference estimation stage and interference cancellation stages are applied separately for each sub-carrier. The final symbol estimates are derived again jointly for two sub-carriers (or time instances). In order to obtain reliable channel estimates, the pilot structure may be altered such that the principle of time, frequency or code orthogonality between the transmit antennas still applies.

Further extension, for example, to four transmit antennas is possible. This would also give diversity for the second service stream and the extension is straightforward. FIG. 8 shows an exemplary arrangement 140 of two pairs of two cross-polarized antennas. The distance d between the two antenna pairs preferably should be large enough in order to provide space diversity. The angles α and θ can be arbitrary, but in practice the most natural choices are 0°, 45° and 90°.

One advantage of utilizing the exemplary embodiments of the invention is the possibility for receivers with existing antenna installations to receive at least a portion (e.g., about half) of the services (or transmitted bits) while receivers with new antennas (e.g., two polarizations) may receive the full services (all bits). This can be achieved without compromising the signal quality or capacity for the full services. According to exemplary embodiments of this invention, receivers with existing antenna installations that use these new algorithms can enjoy the partial services, for example, with near full quality.

Another feature of exemplary embodiments of the invention is that it is very flexible, even on the transmitter side. One can use the existing antenna as is and upgrade the installation with a cross-polarized set of two antennas (see FIG. 6). By proper signal arrangement in the transmitter, this will allow for the use of a special space-time orthogonal coding which leads to the benefits of transmitter space diversity. Again, this is valid for, as an example, half the capacity with existing (i.e., backwards compatible) antenna installations and for full capacity if the receiver uses a new (full) antenna installation.

Another feature, for example, with two cross-polarized antennas, is that the transmitter antennas can be with different angles in respect with each other and the set may be rotated in an arbitrary manner (as long as the transmitter knows these angles). In such cases, the transmitted signals can be so selected and combined that—effectively—vertical and horizontal resulting signals will be transmitted. These horizontal (or in some cases vertical) signals can then be received and decoded by the receivers with existing antenna installations while the receivers with new antenna installations can receive both signals (i.e., full capacity). This allows—for example—the use of antennas at a 45 degree angle from the horizontal position, which might be desirable from the antenna mounting point of view (e.g., for symmetry reasons).

One possible, exemplary way of utilizing exemplary embodiments of this invention is to use this method to provide a robust service to a portable device using basically one polarization and, for example, about half of the total capacity for that purpose. The rooftop antenna receivers with a new antenna installation would then receive the full set of services (i.e., full capacity).

While the backwards compatible mode (i.e., receivers with existing antennas) can decode only a portion of the signal (e.g., about half of the bits), said reception and decoding is clearly preferable to no reception or decoding. It is noted that both polarizations may not be used efficiently if a single antenna handheld is concerned.

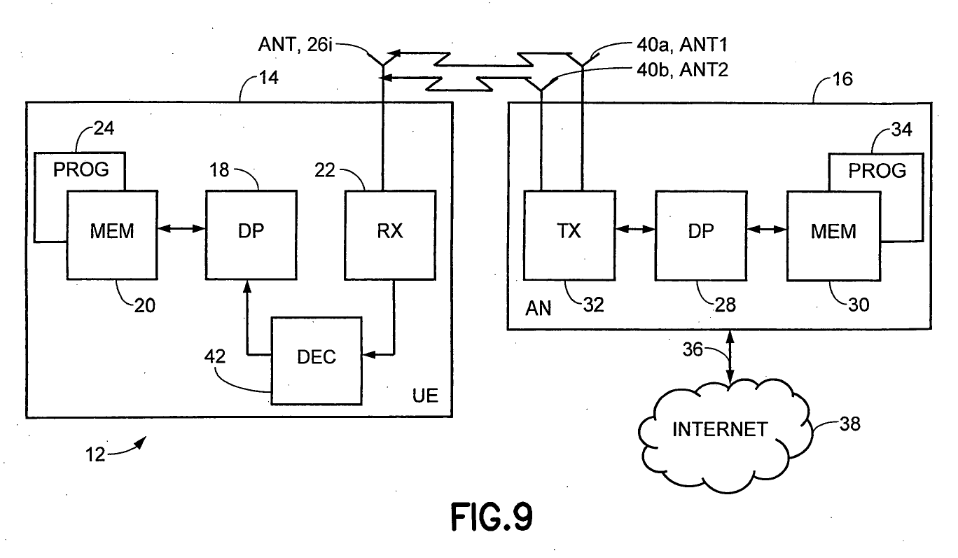

Reference is made to FIG. 9 for illustrating a simplified block diagram of various electronic devices that are suitable for use in practicing the exemplary embodiments of this invention. In FIG. 9, a wireless network 12 is adapted for communication with a user equipment (UE) 14 via an access node (AN) 16. The UE 14 includes a data processor (DP) 18, a memory (MEM) 20 coupled to the DP 18, a decoder (DEC) 42 coupled to the DP 18, and a suitable receiver (RX) 22 coupled to the DEC 42. The MEM 20 stores a program (PROG) 24. The RX 22 is for receiving wireless communications from the AN 16. Note that the RX 22 is coupled to at least one antenna (ANT) 26i to facilitate reception. The DEC 42 is configured to decode signals received by the RX 22 via the ANT 26i. Although not shown in FIG. 9, the UE 14 may also comprise a demodulator to demodulate a received signal and/or a decoded signal.

The AN 16 includes a data processor (DP) 28, a memory (MEM) 30 coupled to the DP 28, and a suitable transmitter (TX) 32 coupled to the DP 28. The MEM 30 stores a program (PROG) 34. The TX 32 is for wireless communications (e.g., MIMO transmissions, broadcast transmissions, multicast transmissions) to the UE 14. Note that the TX 32 has at least two antennas ANT1 40a, ANT2 40b, for example, to facilitate MIMO transmissions. The AN 16 is coupled via a data path 36 to one or more external networks or systems, such as the internet 38, for example. Although not shown in FIG. 9, the AN 16 may also comprise an encoder configured to encode a signal and/or a modulated signal prior to transmission and/or a modulator configured to modulate a signal and/or an encoded signal prior to transmission.

While shown in FIG. 9 with only one antenna ANT 26i, in other exemplary embodiments the UE 14 may comprise more than one antenna. Similarly, while shown in FIG. 9 with two antennas ANT1 40a and ANT2 40b, in other exemplary embodiments the AN 16 may comprise more than two antennas. In order to provide, for example, a MIMO transmission, the ANT 16 will generally comprise a plurality of antennas (i.e., at least two). Furthermore, and in accordance with the exemplary embodiments of the invention as further described herein, it is assumed that the UE 14 comprises a fewer number of antennas than the AN 16.

At least one of the PROGs 24, 34 is assumed to include program instructions that, when executed by the associated DP, enable the electronic device to operate in accordance with the exemplary embodiments of this invention, as discussed herein.

In general, the various exemplary embodiments of the UE 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 28 of the UE 14 and the AN 16, or by hardware, or by a combination of software and hardware.

The MEMs 20, 30 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 28 may be of any type suitable to the local technical environment, and may include one or more of general purpose computers, special purpose computers, microprocessors, digital signal processors (DSPs) and processors based on a multi-core processor architecture, as non-limiting examples.

Although shown in FIG. 9 as a separate component, in other exemplary embodiments the functions performed by the DEC 42 may instead be performed by the DP 18 and/or performed by the DP 18 by executing PROG 24. As non-limiting examples, the DEC 42 may comprise a circuit, a plurality of circuits, an application-specific integrated circuit (ASIC), an integrated circuit, a module and/or a plurality of modules. In further exemplary embodiments, the DEC 42 may comprise a component of the RX 22.

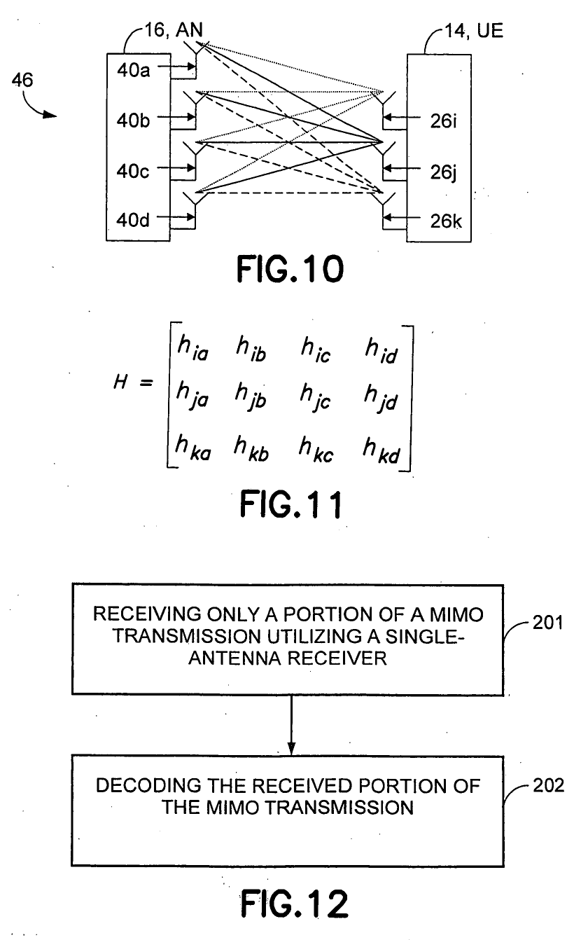

FIG. 10 shows a simplified block diagram of additional electronic devices that are suitable for use in practicing the exemplary embodiments of the invention. In contrast to FIG. 9, the UE 14 of FIG. 10 has three antennas 26i, 26j, 26k. Furthermore, the AN 16 of FIG. 10 has four antennas 40a, 40b, 40c, 40d. For example and not by way of limitation, the exemplary system 42 shown in FIG. 10 will be assumed to have the AN 16 performing a MIMO transmission that is being partially received by the UE 14.

A channel matrix may be generated representing the complex channel gains between each transmitter and receiver antenna pair. The channel matrix for the system 42 shown in FIG. 10 could be represented as a 3×4 matrix. Such an exemplary channel matrix is show in FIG. 11. Here, h_{xy} represents the complex channel gain between the x-th antenna of the UE 14 and the y-th antenna of the AN 16.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

In one non-limiting, exemplary embodiment, and as illustrated in FIG. 12, a method comprising: receiving only a portion of a MIMO transmission utilizing a single-antenna receiver (box 201); and decoding the received portion of the MIMO transmission (box 202).

A method as above, wherein streams of the MIMO transmission are independently coded. A method as in any above, wherein streams of the MIMO transmission are cross-polarized. A method as in any above, wherein a non-received portion of the MIMO transmission is considered as interference with respect to the received portion. A method as in any above, wherein the portion of the MIMO transmission is received by a multi-stage inter-antenna interference cancellation receiver. A method as in any above, wherein the portion of the MIMO transmission is received by an interference cancellation receiver. A method as in any above, wherein cancellation is based on reliable channel estimates from transmit antennas and symbol constellations. A method as in any above, wherein the MIMO transmission comprises a plurality of services, wherein the plurality of services are separately coded and modulated. A method as in any above, wherein the MIMO transmission comprises a plurality of streams, each stream having a different signal power. A method as in any above, wherein observed channels of the MIMO transmission are substantially independent.

A method as in any above, further comprising utilizing common signaling to indicate a symbol constellation of all services. A method as in any above, further comprising receiving information indicative of a symbol constellation of all services for the MIMO transmission. A method as in any above, wherein a receiver comprising a plurality of antennas is configured to receive the entirety of the MIMO transmission. A method as in any above, wherein streams of the MIMO transmission have transmit diversity. A method as in any above, wherein the method is implemented by a user equipment, terminal, mobile device, mobile phone or cellular phone. A method as in any above, wherein the method is implemented by a user equipment of a broadcast system. A method as in any above, wherein the method is implemented by a user equipment of a DVB system. A method as in any above, wherein the method is implemented by a user equipment of an OFDM-based DVB system.

In another exemplary embodiment, a program storage device readable by a machine, tangibly embodying a program of instructions executable by the machine for performing operations, the operations comprising: receiving only a portion of a MIMO transmission utilizing a single-antenna receiver; and decoding the received portion of the MIMO transmission.

A program storage device as above, wherein streams of the MIMO transmission are independently coded. A program storage device as in any above, wherein streams of the MIMO transmission are cross-polarized. A program storage device as in any above, wherein a non-received portion of the MIMO transmission is considered as interference with respect to the received portion. A program storage device as in any above, wherein the portion of the MIMO transmission is received by a multi-stage inter-antenna interference cancellation receiver. A program storage device as in any above, wherein the portion of the MIMO transmission is received by an interference cancellation receiver. A program storage device as in any above, wherein cancellation is based on reliable channel estimates from transmit antennas and symbol constellations. A program storage device as in any above, wherein the MIMO transmission comprises a plurality of services, wherein the plurality of services are separately coded and modulated. A program storage device as in any above, wherein the MIMO transmission comprises a plurality of streams, each stream having a different signal power. A program storage device as in any above, wherein observed channels of the MIMO transmission are substantially independent.

A program storage device as in any above, the operations further comprising utilizing common signaling to indicate a symbol constellation of all services. A program storage device as in any above, the operations further comprising receiving information indicative of a symbol constellation of all services for the MIMO transmission. A program storage device as in any above, wherein a receiver comprising a plurality of antennas is configured to receive the entirety of the MIMO transmission. A program storage device as in any above, wherein streams of the MIMO transmission have transmit diversity. A program storage device as in any above, wherein the program storage device comprises a user equipment, terminal, mobile device, mobile phone or cellular phone. A program storage device as in any above, wherein the program storage device comprises a user equipment of a broadcast system. A program storage device as in any above, wherein the program storage device comprises a user equipment of a DVB system. A program storage device as in any above, wherein the program storage device comprises a user equipment of an OFDM-based DVB system.

In another exemplary embodiment, an apparatus comprising: a receiver configured to receiving only a portion of a MIMO transmission utilizing a single-antenna receiver; and a decoder configured to decoding the received portion of the MIMO transmission.

An apparatus as above, wherein streams of the MIMO transmission are independently coded. An apparatus as in any above, wherein streams of the MIMO transmission are cross-polarized. An apparatus as in any above, wherein a non-received portion of the MIMO transmission is considered as interference with respect to the received portion. An apparatus as in any above, wherein the portion of the MIMO transmission is received by a multi-stage inter-antenna interference cancellation receiver. An apparatus as in any above, wherein the portion of the MIMO transmission is received by an interference cancellation receiver. An apparatus as in any above, wherein cancellation is based on reliable channel estimates from transmit antennas and symbol constellations. An apparatus as in any above, wherein the MIMO transmission comprises a plurality of services, wherein the plurality of services are separately coded and modulated. An apparatus as in any above, wherein the MIMO transmission comprises a plurality of streams, each stream having a different signal power. An apparatus as in any above, wherein observed channels of the MIMO transmission are substantially independent.

An apparatus as in any above, wherein common signaling is utilized to indicate a symbol constellation of all services. An apparatus as in any above, wherein the receiver is further configured to receive information indicative of a symbol constellation of all services for the MIMO transmission. An apparatus as in any above, wherein a receiver comprising a plurality of antennas is configured to receive the entirety of the MIMO transmission. An apparatus as in any above, wherein streams of the MIMO transmission have transmit diversity. An apparatus as in any above, wherein the apparatus comprises a user equipment, terminal, mobile device, mobile phone or cellular phone. An apparatus as in any above, wherein the apparatus comprises a user equipment of a broadcast system. An apparatus as in any above, wherein the apparatus comprises a user equipment of a DVB system. An apparatus as in any above, wherein the apparatus comprises a user equipment of an OFDM-based DVB system.

In another exemplary embodiment, an apparatus comprising: means for receiving only a portion of a MIMO transmission utilizing a single-antenna receiver; and means for decoding the received portion of the MIMO transmission.

An apparatus as above, wherein the means for receiving comprises a receiver and the means for decoding comprises a decoder. An apparatus as in any above, wherein streams of the MIMO transmission are independently coded. An apparatus as in any above, wherein streams of the MIMO transmission are cross-polarized. An apparatus as in any above, wherein a non-received portion of the MIMO transmission is considered as interference with respect to the received portion. An apparatus as in any above, wherein the portion of the MIMO transmission is received by a multi-stage inter-antenna interference cancellation receiver. An apparatus as in any above, wherein the portion of the MIMO transmission is received by an interference cancellation receiver. An apparatus as in any above, wherein cancellation is based on reliable channel estimates from transmit antennas and symbol constellations. An apparatus as in any above, wherein the MIMO transmission comprises a plurality of services, wherein the plurality of services are separately coded and modulated. An apparatus as in any above, wherein the MIMO transmission comprises a plurality of streams, each stream having a different signal power. An apparatus as in any above, wherein observed channels of the MIMO transmission are substantially independent.

An apparatus as in any above, wherein common signaling is utilized to indicate a symbol constellation of all services. An apparatus as in any above, further comprising: means for receiving information indicative of a symbol constellation of all services for the MIMO transmission. An apparatus as in any above, wherein a means for receiving comprising a plurality of antennas is configured to receive the entirety of the MIMO transmission. An apparatus as in any above, wherein streams of the MIMO transmission have transmit diversity. An apparatus as in any above, wherein the apparatus comprises a user equipment, terminal, mobile device, mobile phone or cellular phone. An apparatus as in any above, wherein the apparatus comprises a user equipment of a broadcast system. An apparatus as in any above, wherein the apparatus comprises a user equipment of a DVB system. An apparatus as in any above, wherein the apparatus comprises a user equipment of an OFDM-based DVB system.

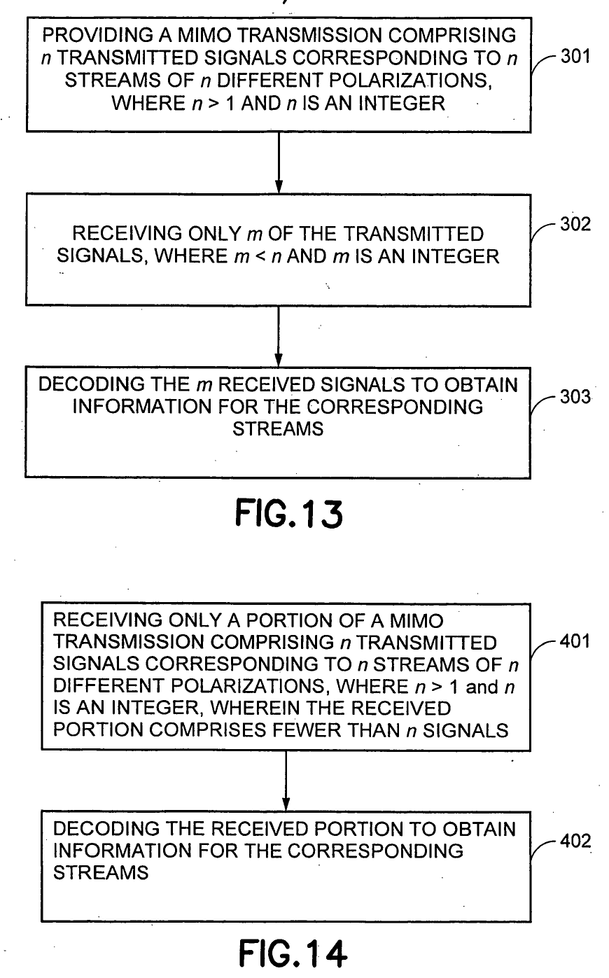

In another exemplary embodiment, and as shown in FIG. 13, a method comprising: providing a MIMO transmission comprising n transmitted signals corresponding to n streams of n different polarizations, where n>1 and n is an integer (box 301); receiving only m of the transmitted signals, where m<n and m is an integer (box 302); and decoding the m received signals to obtain information for the corresponding streams (box 303). A method as above, further comprising one or more additional aspects of the exemplary embodiments of the invention as further described herein.

In another exemplary embodiment, a program storage device readable by a machine, tangibly embodying a program of instructions executable by the machine for performing operations, the operations comprising: providing a MIMO transmission comprising n transmitted signals corresponding to n streams of n different polarizations, where n>1 and n is an integer; receiving only m of the transmitted signals, where m<n and m is an integer; and decoding the m received signals to obtain information for the corresponding streams. A program storage device as above, further comprising one or more additional aspects of the exemplary embodiments of the invention as further described herein.

In another exemplary embodiment, an apparatus comprising: a receiver configured to receive m transmitted signals of a MIMO transmission comprising n transmitted signals corresponding to n streams of n different polarizations, where n>1 and n is an integer, where m<n and m is an integer; and a decoder configured to decode the m received signals to obtain information for the corresponding streams. An apparatus as above, further comprising one or more additional aspects of the exemplary embodiments of the invention as further described herein.

In another exemplary embodiment, an apparatus comprising: means for receiving m transmitted signals of a MIMO transmission comprising n transmitted signals corresponding to n streams of n different polarizations, where n>1 and n is an integer, where m<n and m is an integer; and means for decoding the m received signals to obtain information for the corresponding streams. An apparatus as above, wherein the means for receiving comprises a receiver and the means for decoding comprises a decoder. An apparatus as above, further comprising one or more additional aspects of the exemplary embodiments of the invention as further described herein.

In another exemplary embodiment, and as shown in FIG. 14, a method comprising: receiving only a portion of a MIMO transmission comprising n transmitted signals corresponding to n streams of n different polarizations, where n>1 and n is an integer, wherein the received portion comprises fewer than n signals (box 401); and decoding the received portion to obtain information for the corresponding streams (box 402). A method as above, further comprising one or more additional aspects of the exemplary embodiments of the invention as further described herein.

In another exemplary embodiment, a program storage device readable by a machine, tangibly embodying a program of instructions executable by the machine for performing operations, the operations comprising: receiving only a portion of a MIMO transmission comprising n transmitted signals corresponding to n streams of n different polarizations, where n>1 and n is an integer, wherein the received portion comprises fewer than n signals; and decoding the received portion to obtain information for the corresponding streams. A program storage device as above, further comprising one or more additional aspects of the exemplary embodiments of the invention as further described herein.

In another exemplary embodiment, an apparatus comprising: a receiver configured to receive only a portion of a MIMO transmission comprising n transmitted signals corresponding to n streams of n different polarizations, where n>1 and n is an integer, wherein the received portion comprises fewer than n signals; and a decoder configured to decode the received portion to obtain information for the corresponding streams. An apparatus as above, further comprising one or more additional aspects of the exemplary embodiments of the invention as further described herein.

In another exemplary embodiment, an apparatus comprising: means for receiving only a portion of a MIMO transmission comprising n transmitted signals corresponding to n streams of n different polarizations, where n>1 and n is an integer, wherein the received portion comprises fewer than n signals; and means for decoding the received portion to obtain information for the corresponding streams. An apparatus as above, wherein the means for receiving comprises a receiver and the means for decoding comprises a decoder. An apparatus as above, further comprising one or more additional aspects of the exemplary embodiments of the invention as further described herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of MIMO communication, it should be appreciated that the exemplary embodiments of this invention are not limited for use with only this one particular type of wireless communication system, and that they may be used to advantage in other wireless communication systems that utilize a plurality of antennas for transmission.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, any use of the term “portion” as in “only a portion” should be construed as “less than the whole” (i.e., not including the entirety). In contrast, any use of the term “portion” as in “at least a portion” should be construed as “a portion or the whole” (at least a portion and possibly the entirety).

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
receiving m transmitted signals of a multiple input/multiple output transmission comprising n transmitted signals corresponding to n streams of n different polarizations, where n is a positive integer greater than one and m is an integer less than n; and
decoding the m received signals to obtain information for the corresponding streams.

2. The method according to claim 1, wherein streams of the multiple input/multiple output transmission are independently coded and cross-polarized.

3. The method according to claim 1, wherein the decoding comprises considering a portion of the multiple input/multiple output transmission apart from the received m transmitted signals as interference with respect to the received m transmitted signals.

4. The method according to claim 3, wherein the portion of the multiple input/multiple output transmission apart from the received m transmitted signals is sent to a multi-stage inter-antenna interference cancellation receiver wherein cancellation is based on reliable channel estimates from transmit antennas and symbol constellations.

5. The method according to claim 2, wherein the multiple input/multiple output transmission comprises a plurality of services which are separately coded and modulated, and a plurality of streams where each stream has a different signal power.

6. The method according to claim 5, further comprising utilizing common signaling to indicate a symbol constellation of all the plurality of services.

7. The method according to claim 2, wherein observed channels of the multiple input/multiple output transmission are substantially independent.

8. The method according to claim 1, wherein the receiving is by a receiver comprising a plurality of antennas, wherein the receiver is configured to receive the entirety of the multiple input/multiple output transmission.

9. A memory readable by a processor, tangibly embodying a program of instructions that when executed by the processor result in operations comprising:
receiving m transmitted signals of a multiple input/multiple output transmission comprising n transmitted signals corresponding to n streams of n different polarizations, where n is a positive integer greater than one and m is an integer less than n; and
decoding the m received signals to obtain information for the corresponding streams.

10. The memory as in claim 10, wherein the multiple input/multiple output transmission comprises a plurality of digital video broadcast services that are separately coded and modulated, and a plurality of streams where each stream has a different signal power.

11. An apparatus comprising:
a receiver configured to receive m transmitted signals of a multiple input/multiple output comprising n transmitted signals corresponding to n streams of n different polarizations, where n is a positive integer greater than one and m is an integer less than n; and
a decoder configured to decode the m received signals to obtain information for the corresponding streams.

12. The apparatus according to claim 11, wherein the streams of the multiple input/multiple output transmission are independently coded and cross-polarized.

13. The apparatus according to claim 11, wherein the decoder is configured to consider a portion of the multiple input/multiple output transmission apart from the received m transmitted signals as interference with respect to the received m transmitted signals.

14. The apparatus according to claim 13, further comprising a multi-stage inter-antenna inference cancellation receiver to which the portion of the multiple input/multiple output transmission apart from the received m transmitted signals is sent, and in which cancellation is based on reliable channel estimates from transmit antennas and symbol constellations.

15. The apparatus according to claim 12, wherein the multiple input/multiple output transmission comprises a plurality of services which are separately coded and modulated, and a plurality of streams where each stream has a different signal power.

16. The apparatus according to claim 15, in which common signaling is utilized to indicate a symbol constellation of all the plurality of services.

17. The apparatus according to claim 12, wherein observed channels of the multiple input/multiple output transmission are substantially independent.

18. The apparatus according to claim 11, further comprising a receiver and a plurality of antennas which are configured to receive the entirety of the multiple input/multiple output transmission.

19. An apparatus comprising a processor configured to:
receive m transmitted signals of a multiple input/multiple output transmission comprising n transmitted signals corresponding to n streams of n different polarizations, where n is a positive integer greater than one and m is an integer less than n; and
decode the m received signals to obtain information for the corresponding streams.

20. The apparatus according to claim 19, in which the streams of the multiple input/multiple output transmission are independently coded and cross-polarized.

21. The apparatus according to claim 19, wherein the m received signals are decoded by considering a portion of the multiple input/multiple output transmission apart from the received m transmitted signals as interference with respect to the received m transmitted signals.

22. The method according to claim 2, wherein the decoding comprises considering a portion of the multiple input/multiple output transmission apart from the received m transmitted signals as interference with respect to the received m transmitted signals.

23. The method according to claim 22, wherein the portion of the multiple input/multiple output transmission apart from the received m transmitted signals is sent to a multi-stage inter-antenna interference cancellation receiver wherein cancellation is based on reliable channel estimates from transmit antennas and symbol constellations.

24. The method according to claim 2, wherein the receiving is by a receiver comprising a plurality of antennas, wherein the receiver is configured to receive the entirety of the multiple input/multiple output transmission.

25. The apparatus according to claim 12, wherein the decoder is configured to consider a portion of the multiple input/multiple output transmission apart from the received m transmitted signals as interference with respect to the received m transmitted signals.

26. The apparatus according to claim 25, further comprising a multi-stage inter-antenna inference cancellation receiver to which the portion of the multiple input/multiple output transmission apart from the received m transmitted signals is sent, and in which cancellation is based on reliable channel estimates from transmit antennas and symbol constellations.

27. The apparatus according to claim 12, further comprising a receiver and a plurality of antennas which are configured to receive the entirety of the multiple input/multiple output transmission.

28. The apparatus according to claim 20, wherein the m received signals are decoded by considering a portion of the multiple input/multiple output transmission apart from the received m transmitted signals as interference with respect to the received m transmitted signals.
